(19) United States
(12) Patent Application Publication
(10) Pub. No.: US 2005/0056215 A1
(43) Pub. Date: Mar. 17, 2005

(54) Apparatus for applying paste and method of applying paste

(75) Inventor: Noriaki Shimoda, Yokohama-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Shibaura Mechantronics Corporation, Yokohama-shi (JP)

(21) Appl. No.: 10/793,383

(22) Filed: Mar. 4, 2004

(30) Foreign Application Priority Data
Mar. 11, 2003 (JP) 2003-065816

(51) Int. Cl. B05C 13/00; B05C 21/00

(52) U.S. Cl. 118/668; 118/500; 118/669

(57) ABSTRACT

An applying apparatus, which applies paste in a preset pattern to a substrate, includes a stage having a holding surface on which the substrate is placed, a beam member extending above the stage in a direction along the holding surface, a moving device which relatively moves the beam member and the stage in a direction along the holding surface and perpendicular to the extending direction of the beam member, a guide member provided on the beam member and along the extending direction of the beam member, an applying head which is supported by the guide member and movable along the guide member, and a plurality of suction nozzles which are provided along the guide member and suck air in the vicinity of the guide member.

### CROSS-REFERENCE TO RELATED APPLICATIONS

This application is based upon and claims the benefit of priority from prior Japanese Patent Application No. 2003-65816, filed Mar. 11, 2003, the entire contents of which are incorporated herein by reference.

### BACKGROUND OF THE INVENTION

1 Field of the Invention

This invention relates to a paste applying apparatus and a method of applying paste, for applying paste in a preset pattern on a substrate.

2 Description of the Related Art

In conventional paste applying apparatuses which apply paste in a preset pattern on a substrate, a frame which is movable by a linear motor in a predetermined direction is disposed above a stage on which a substrate is placed. The frame is provided with a plurality of applying heads which are movable in a direction perpendicular to the moving direction of the frame.

By the above structure, it is possible to apply paste in a plurality of desired patterns on a substrate simultaneously, by moving the plurality of applying heads on the frame while moving the frame. Such a technique is disclosed in, for example, Jpn. Pat. Appln. KOKAI Pub. No. 2002-346452.

In the above paste applying apparatus, a linear motor is used as device for moving the applying heads moving above a substrate. Therefore, the apparatus generates little dust caused by movement of the applying heads, and can prevent contamination of substrates due to dust.

However, although the above paste applying apparatus suppresses generation of dust by using a linear motor for moving the applying heads, it uses linear guides for movably supporting the applying heads. A linear guide has a guide rail and a movable table which moves along the guide rail. Therefore, dust such as metal powder is generated from a sliding portion between the guide rail and the movable table, and the dust contaminates substrates.

### BRIEF SUMMARY OF THE INVENTION

The object of the present invention is to provide a paste applying apparatus and a paste applying method, which suppress contamination of substrates by dust and enables good paste application.

According to the present invention, there is provided an applying apparatus which applies paste in a preset pattern to a substrate, comprising:
a stage having a holding surface on which the substrate is placed;
a beam member extending above the stage in a direction along the holding surface;
a moving device which relatively moves the beam member and the stage, in a direction along the holding surface and perpendicular to the extending direction of the beam member;
a guide member provided on the beam member and along the extending direction of the beam member;
an applying head which is supported by the guide member and movable along the guide member; and
a plurality of suction portions which are provided along the guide member and suck air in the vicinity of the guide member.

According to the present invention, there are provided suction portions which suck air in the vicinity of the guide member guiding the applying head. Therefore, even if dust is generated by moving the applying head along the guide member, the dust can be sucked and removed by the suction portions, and good paste application is achieved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a perspective view of a structure of a paste applying apparatus according to the present invention.

FIG. 2 is a front view of a structure of a main part of the paste applying apparatus shown in FIG. 1.

FIG. 3 is a cross-sectional view taken along line III-III of FIG. 2.

FIG. 4 is a block diagram of a control unit in the paste applying apparatus shown in FIG. 1.

FIG. 5 is a diagram for explaining operation of the paste applying apparatus shown in FIG. 1, when two applying heads thereof are moved in opposite directions.

FIG. 6 is a diagram for explaining operation of the paste applying apparatus shown in FIG. 1, when the two applying heads thereof are moved in the same direction.

### DETAILED DESCRIPTION OF THE INVENTION

An embodiment of the present invention is explained with reference to drawings.

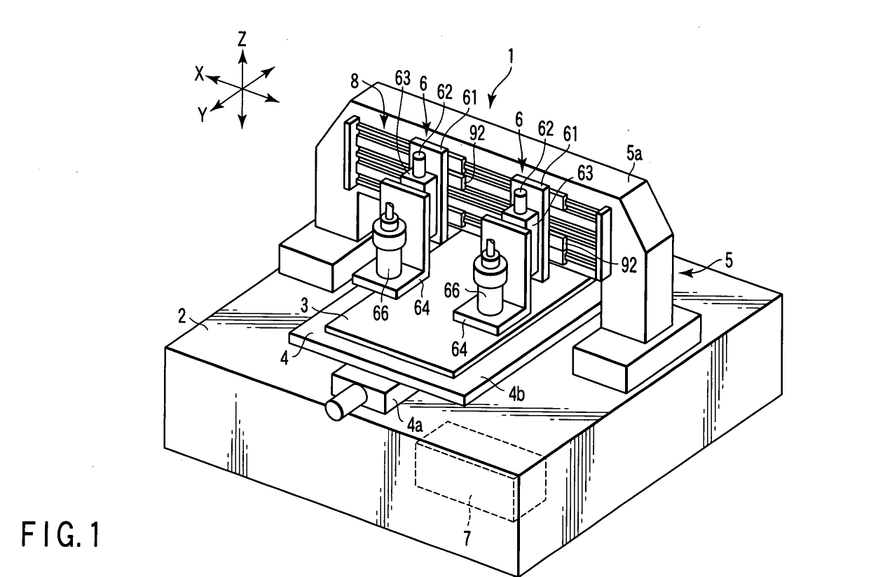

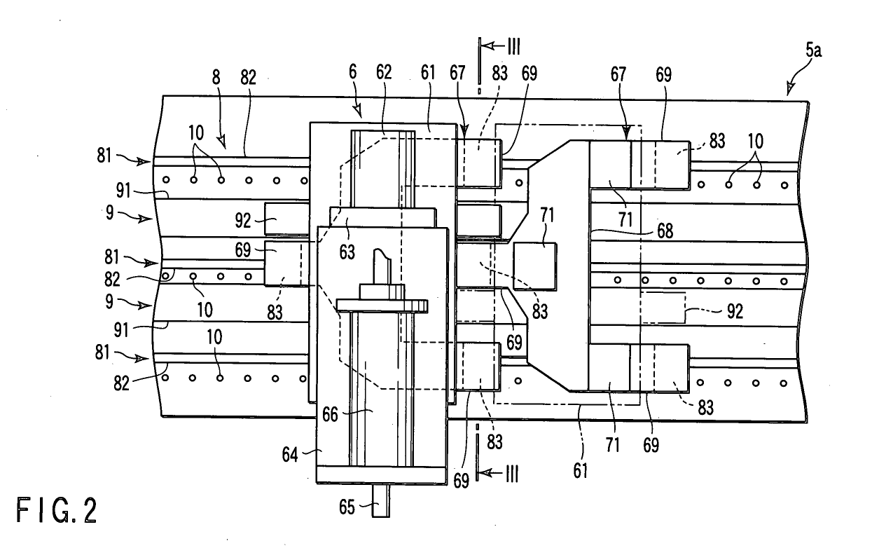

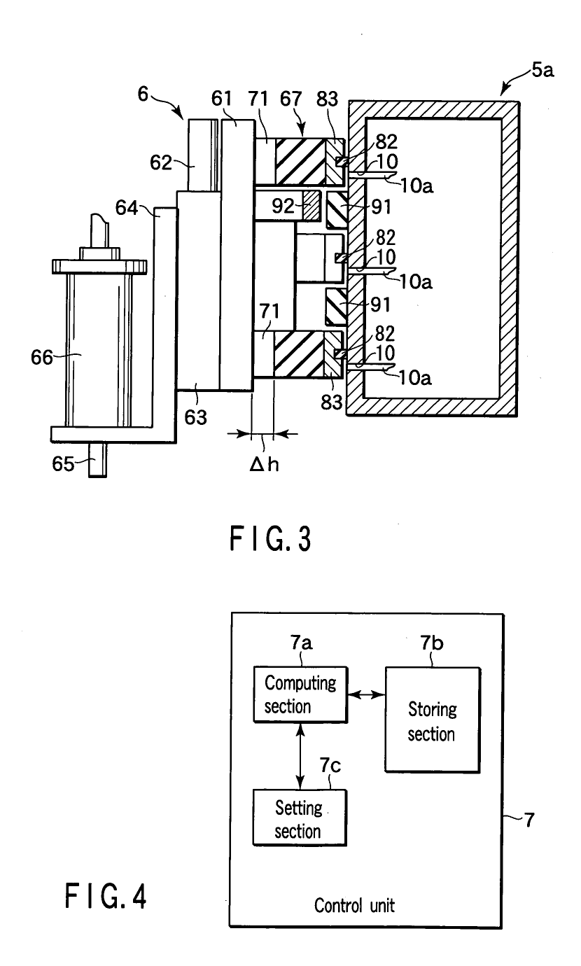

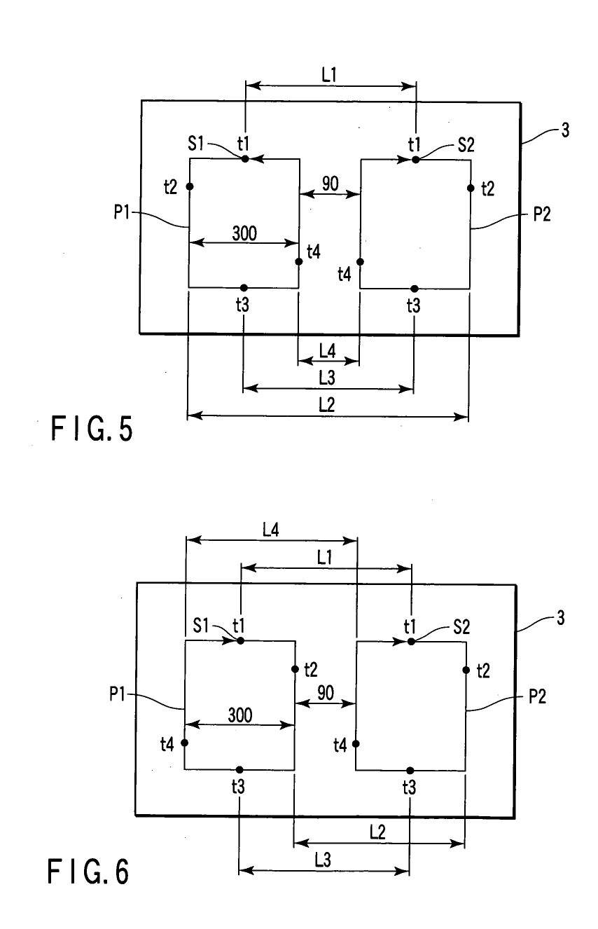

FIG. 1 is a perspective view of a structure of a paste applying apparatus according to the present invention, FIG. 2 is a front view of a structure of a main part of the paste applying apparatus shown in FIG. 1, FIG. 3 is a cross-sectional view taken along line III-III of FIG. 2, FIG. 4 is a diagram illustrating a structure of a control unit in the paste applying apparatus shown in FIG. 1, and FIGS. 5 and 6 are diagrams for explaining operation of the paste applying apparatus shown in FIG. 1.

In FIG. 1, a paste applying apparatus 1 comprises a base 2, a stage 4 which is disposed on the base 2 and on which a substrate 3 is placed, a gate-shaped frame 5 fixed on the base 2, two applying heads 6 which are movably supported by a beam member 5a of the frame 5, and a control unit 7 disposed in the base 2.

FIG. 1 shows X, Y and Z directions by arrows. The stage 4 is disposed on the base 2 with a Y-axis moving table 4a, serving as a first moving device, interposed therebetween. The Y-axis moving table 4a drives the stage 4 in the Y direction represented by arrows. Adsorption holes (not shown) for adsorbing and holding the substrate 3 are formed in a holding surface 4b of the stage 4. Further, the stage 4 is also provided with lift pins (not shown) for receiving the substrate 3 from, and transferring the substrate 3 to, the holding surface 4b by a substrate-carrying robot (not shown).

The frame 5 is fixed and disposed on the base 2, being astride (crossing over) the stage 4 in the X direction represented by arrows.

The two applying heads 6 are movably provided on a front surface of the beam member 5a extending in the X arrow direction of the frame 5, with a guide device 8.

As shown in FIG. 2, each of the applying heads 6 comprises an X-axis moving table 61 supported by the guide device 8, an elevating mechanism 63 using a feed screw mechanism which is vertically movably supported on the X-axis moving table 61 and driven by a motor 62, a Z-axis moving table 64 which is driven by the elevating mechanism 63 to ascend and descend, and a syringe 66 which is fixed on the Z-axis moving table 64 and has an applying nozzle 65 for discharging paste.

Also as shown in FIG. 2, the guide device 8 has three linear guides 81. The linear guides 81 have three guide rails (guide member) 82 provided vertically in parallel with one another on the beam member 5a, and movable tables 83 which are slidably provided on the guide rails 82. The movable tables 83 are fixed onto the X-axis moving tables 61 of the applying heads 6 with mounting members 67. The mounting members 67 are attached onto the respective X-axis moving tables 61 with spacers 71.

As shown in FIG. 2, each mounting member 67 has a structure in which three arm portions 69 are projected leftward and rightward in a staggered format from a base portion 68, such that they correspond to the three guide rails 82. The movable tables 83 are fixed onto the respective arm portions 69. Therefore, between the adjacent two applying heads 6, the movable tables 83 on the same guide rails 82 project in the same direction. Further, three movable tables 83 are arranged in a staggered format with respect to the X-axis moving table 61 of each applying head 6.

In FIG. 2, although one of the pair of applying heads 6 is shown by solid lines, the mounting member 67 of the other head is shown by solid lines and the X-axis moving table 61 thereof fixed onto the mounting member 67 is shown by chain double-dashed line.

The applying heads 6 are driven in the X direction by the linear motor 9 serving as the second moving device. The linear motor 9 is formed of magnets 91 serving as stators arranged in two upper and lower lines running along the three guide rails 82, and coils 92 serving as moving element fixed onto the respective X-axis moving tables 61. One of the coils 92 is fixed onto the X-axis moving table 61 of the left applying head 6 of the two applying heads 6, in a position corresponding to the magnet 91 disposed in the upper line. The other of the coils 92 is fixed onto the X-axis moving table 61 of the right applying head 6, in a position corresponding to the magnet 91 disposed in the lower line.

On the lower side of each guide rail 82, a plurality of suction holes 10 serving as suction portions are arranged along the guide rail 82 at regular intervals. The suction holes 10 are connected to a vacuum source (not shown) through respective pipes 10a shown in FIG. 3, and configured to allow generation of vacuum suction force according to necessity by using an opening/closing mechanism of a pipe, such as a solenoid valve. The sucked air is discharged through the pipes 10a to the outside of the chamber in which the paste applying apparatus 1 is placed.

As shown in FIG. 4, the control unit 7 comprises a computing section 7a, a storing section 7b, and a setting section 7c. The storing section 7b stores application conditions necessary for performing paste application. For example, it stores application pattern data, relative moving speed between the substrate 3 and the applying heads 6 which is application speed corresponding to the application pattern data, a gap between the substrate 3 and the applying nozzles 65 being a gap in paste application, and discharge pressure of the paste, etc.

In the setting section 7c, a close distance L between the two applying heads 6 is set. The term “close distance L” means a minimum distance between the two applying heads 6, at which the two applying heads 6 can approach each other on the guide device 8 without interference. The computing section 7a controls movements of the applying heads 6 and the stage 4 in application, on the basis of the data stored in the storing section 7b, and judges whether the data stored in the storing section 7b is proper or not.

The judgment of propriety of the data stored in the storing section 7b is detailed later. Data can be input in the storing section 7b and the setting section 7c by using an input operation section (not shown), such as a keyboard and a touch panel.

Next, the operation of the apparatus is described.

When performing application of paste to the substrate 3, first, application conditions necessary for applying paste to the substrate 3 to be treated in this operation are stored in the storing section 7b. After storing the application conditions in the storing section 7b, the computing section 7a judges whether the data stored in the storing section 7b is proper or not as follows, on the basis of the application conditions in the storing section 7b and the close distance L set in the setting section 7c.

For example, as shown in FIG. 5, suppose that two rectangular patterns P1 and P2 are simultaneously drawn on the substrate 3. Suppose that the storing section 7b stores data for drawing a rectangular pattern counterclockwise from a position S1 on the substrate 3 serving as application starting position, as application pattern data for the left applying head 6, and data for drawing a rectangular pattern clockwise from a position S2 on the substrate 3 serving as application starting position, as application pattern data for the right applying head 6. Except for the pattern data, the same conditions such as applying speed are set for the two applying heads 6, and a close distance L of 100 mm is preset in the setting section 7c.

The computing section 7a computes relative distances L1, L2, L3 and L4 between the applying heads 6 corresponding to respective elapsed times t1, t2, t3 and t4 between the start and the end of application, based on the application conditions stored in the storing section 7b. In the example shown in FIG. 5, paste is applied in two rectangles each having a width of 300 mm and being distant from each other by 90 mm. In FIG. 5, L1=390 mm, L2=690 mm, L3=390 mm, and L4=90 mm.

Next, the computing section 7a compares each of the computed relative distances with the close distance L set in the setting section 7c, and determines whether any relative distance is equal to or smaller than the close distance L. As a result of determination, if there is any relative distance equal to or smaller than the close distance L, the computing section judges that the application conditions stored in the storing section 7c are improper, since with the conditions the two applying heads 6 cannot simultaneously draw the application patterns P1 and P2 shown in FIG. 5. Then, the computing section 7a urges the operator, via a monitor and an alarm device (not shown), to correct the data. In the example of FIG. 5, the distance L4 being 90 mm is smaller than the close distance L being 100 mm, and thus the computing section 7a judges that the application conditions stored in the storing section 7b are improper.

In the above example, the computing section 7a compares each of the relative distances with the close distance L after computing all the relative distances between the applying heads 6 for the respective elapsed times from the start to the end of application. As another example, each time a relative distance between the applying heads 6 at a time elapsed from the start of the application is computed, the computing section may compare the computed relative distance with the close distance L, and make the above judgment at the time when the relative distance is equal to or smaller than the close distance L.

By the above method, it is possible to judge propriety of the application conditions stored in the storing section 7b, at the time when it is determined that there is a part at which the relative distance is equal to or smaller than L in the application pattern. Therefore, prompt judgment is possible in comparison with the former method.

As the result of prompting the operator to correct the application conditions through a monitor or alarm device, if the application conditions stored in the storing section 7b are corrected, the computing section 7a also judges whether the corrected application conditions are proper or not in the same manner. In this step, as shown in FIG. 6, suppose that the same clockwise application data is set to the left and right applying heads 6, with the respective application starting positions of S1 and S2 on the substrate 3. In this case, the relative distances L1, L2, L3 and L4 between the applying heads 6 of the respective elapsed times t1, t2, t3 and t4 are 390 mm, 390 mm, 390 mm, 390 mm, respectively, and are greater than the close distance L (100 mm). Therefore, the computing section 7a judges that the data stored in the storing section 7b is proper.

The following operation is performed on the basis of the application conditions judged as proper by the above judgment.

The substrate 3 supplied by a substrate-carrying robot (not shown) is transferred onto the lift pins waiting at the ascent position, and then the lift pins descend and the substrate 3 is placed on the holding surface 4b of the stage 4. The substrate 3 placed on the stage 4 is adsorbed by the adsorption holes (not shown) and fixed thereon.

When the substrate 3 is fixed onto the stage 4, the computing section 7a detects a position-detecting mark attached to the substrate 3 by using a position-detecting camera (not shown), and recognizes the position of the substrate 3. Then, based on the result of the position recognition and the data stored in the storing section 7b, the computing section 7a positions the applying heads 6 in the respective waiting positions, for example, the application starting positions S1 and S2 of the respective application patterns to be drawn, from the left and right ends of the guide device 8. In this step, prior to movement of the applying heads 6, that is, drive of the linear motor 9, the computing section 7a opens a solenoid valve (not shown) to generate vacuum suction force at the suction holes 10.

Thereafter, the computing section 7a controls movements of the stage 4 and each of the applying heads 6 on the basis of the data stored in the storing section 7b, and applies paste onto the substrate 3 in accordance with the stored application conditions. Publicly-known art can be used for controlling the applying heads 6 in the applying operation, and the control thereof is not described.

When application of the paste to the substrate 3 is completed, the computing section 7a moves the applying heads 6 to the respective waiting positions, and releases adsorption by the adsorption holes (not shown). Thereafter, the substrate 3 to which the paste has been applied is lifted by the lift pins. Further, when movement of the applying heads 6 to the waiting positions is completed, the computing section 7a closes the solenoid valve to stop the vacuum suction force generated at the suction holes 10. If a plurality of substrates 3 are successively treated, the vacuum suction force may be kept generated at the suction holes 10 until application to the last substrate is completed.

Then, the lifted substrate 3 is carried out by the substrate-carrying robot, and thereby paste application operation to one substrate is completed.

According to the above embodiment, the applying heads 6 arranged above the stage 4 are moved by the linear motor 9. Further, a plurality of suction holes 10 are arranged at regular intervals along the guide rails 82 of the guide device 8 supporting the applying heads 6, and vacuum suction force is generated at the suction holes 10 when the applying heads 6 are moved. The linear motor 9 has a structure in which the coils 92 are kept from contact with the magnets 91 in moving, and thus generation of dust is suppressed.

Further, even if dust such as metal powder is generated in the sliding portions between the guide rails 82 and the movable tables 83, the dust is sucked into the suction holes 10 by the airflow caused by the suction force generated at the suction holes 10, and is prevented from falling onto the substrate 3. Therefore, contamination of the substrate 3 due to dust is reduced to the minimum, and it is possible to improve the quality of products manufactured by using the paste-applied substrate 3.

Further, the linear motor 9 is cooled by the airflow in the suction direction generated by the vacuum suction force generated at the suction hole 10. Thereby, even if the linear motor 9 generates heat by energizing the coils 92, rise in temperature due to the generated heat is prevented, and thermal expansion of each member by heat is prevented. As a result, decrease in the movement accuracy of the linear motor 9 caused by thermal expansion is prevented, and thus stable and accurate paste application is achieved.

Furthermore, prior to start of application, that is, before positioning the applying heads 6 in the application starting position, the operating section 7a judges whether the application conditions stored in the storing section 7b is proper or not, that is, whether the two applying heads 6 interfere with each other during application operation, on the basis of the application conditions stored in the storing section 7b and the close distance L set in the setting section 7c.

Therefore, even if the application pattern data and applying speed are set in the storing section 7b with conditions under which the two applying heads 6 interfere with each other, application operation under the conditions is prevented from being carried out.

Therefore, as shown in FIG. 5, even if application conditions are set under which the applying heads do not interfere at the application starting positions (t1) but interfere during drawing the application pattern (t4), application operation under the application conditions is avoided. It is thus possible to prevent interruption of application operation due to interference between the pair of applying heads 6, and perform efficient application.

Even in the application pattern shown in FIG. 5, application can be carried out under application conditions under which the applying heads 6 do not interfere. In such a case, the two applying heads 6 simultaneously move at the same speed in the opposite directions on the guide device 8. This movement cancels force of bending the frame 5 caused by inertia of the applying heads 6 in acceleration/deceleration of the two applying heads 6, and can prevent decrease in the application accuracy due to bend and deformation of the frame 5.

Further, with respect to the applying heads 6, the movable tables 83 of the three guide rails 82 are arranged and fixed such that they project leftwards and rightwards in a staggered format from the X-axis moving table 61 of each of the applying heads 6. This structure can reduce shake (backlash) of the applying heads 6 with an axis of the Z arrow direction to the minimum.

Specifically, in the linear guides 81, it is difficult to completely remove backlash between the guide rails 82 and the movable tables 83, and it has some backlash. This backlash causes shake of the applying heads 6 with an axis of the Z arrow direction.

Further, the magnitude of the shake is inversely proportional to the length between end portions of the movable tables 83 in the moving direction thereof (referred to as “moving direction length” hereinafter). Therefore, the shake of the applying heads 6 with the axis in the Z arrow direction can be reduced by increasing the moving direction intervals between the movable tables 83 provided to the applying heads 6.

Therefore, as in this embodiment, the movable tables 83 are projected leftwards and rightwards with respect to the X-axis moving table 61 of each of the applying heads 6, and thereby shake with the axis in the Z arrow direction can be reduced in comparison with the case of providing the movable tables 83 with the same width (moving direction length) of as that of the X-axis moving table 61.

Further, the movable tables 83 are arranged such that the movable tables 83 on the same guide rail 82 project in the same direction between the two applying heads 6, and that they project leftwards and rightwards in a staggered format with respect to one X-axis table 61. Therefore, even when the two applying heads 6 approach each other, the movable tables 83 projecting from the X-axis moving tables 61 are prevented from interfering with each other and impeding approach of the applying heads 6.

Specifically, as shown in FIG. 2, the movable table 83 projecting from the left side of the right X-axis moving table 61 is interposed between the two movable tables 83 projecting from the right side of the left X-axis moving table 61. It is thus possible to bring the applying heads 6 close to each other, without interference of the movable tables 83.

Further, in the example shown in FIG. 2, spaces Δh are provided between the arm portions 69, to which the movable tables 83 are provided, and the X-axis moving table 61 by the spacers 71 as shown in FIG. 3, such that the movable tables 83 can enter under the X-axis moving tables 61. This structure can further bring the applying heads 6 close to each other.

According to the above structure, it is possible to reduce the close distance L between the two applying heads 6 to the minimum, while shake of the applying heads 6 with an axis of the Z arrow direction is suppressed to the minimum. This enables accurate paste application using two applying heads 6 simultaneously to adjacent patterns, and improvement in the application quality.

Further, the two magnets 91 serving as stators are arranged to be vertically parallel to each other. The coil 92 serving as moving element for the X-axis moving table 61 of the left applying head 6 is fixed to a position corresponding to the upper magnet 91. The coil 92 for the X-axis moving table 61 of the right applying head 6 is fixed to a position corresponding to the lower magnet 91. Therefore, even if the both ends of each coil 92 project leftwards and rightwards from the X-axis moving table 61 as shown in FIG. 2, the coils 92 for the respective applying heads 6 do not interfere, and the applying heads 6 can be brought to close to each other.

The magnitude of the thrust of the linear motor 9 is increased with increase in the size of the coil 92, for example, the number of turns of the coil 92, with respect to the magnets 91 of the same type. If there are plurality of coils, the thrust of the linear motor 9 is increased as the number of the coils increases. Therefore, a greater thrust is obtained by increasing the length of the coil 92 in the direction parallel to the magnet 91, and a faster acceleration/deceleration speed is achieved for the applying head 6 of the same weight.

This structure can reduce the close distance L between the two applying heads 6 to the minimum, while a greater thrust is maintained, in comparison with the case of using the coils 92 having the same length as the width of the X-axis moving tables 61. Therefore, the two applying heads 6 can simultaneously apply paste even to close patterns at high speed, and the application efficiency is greatly improved.

Although the two applying heads are provided in the above embodiment, the present invention is not limited to it. The number of the applying heads 6 may be 1 or 3 or more.

Although one frame 5 is provided to support the applying heads 6 in the above embodiment, the present invention may have a structure in which two or more frames 5 are provided and applying heads 6 are provided to the respective frames.

Although the frame 5 is fixed onto the base 2 in the above embodiment, the frame 5 may be provided to the base 2 so as to be movable in the Y direction by a Y-axis moving table interposed therebetween. According to this structure, when paste is applied in a pattern along the Y direction, the stage 4 and the frame 5 is simultaneously moved in the opposite directions. Thereby, paste can be applied at higher speed in comparison with the case of moving only the stage 4, and the application efficiency is improved.

Although the guide device 8 has the three linear guides 81 in the above embodiment, the number of the linear guides 81 may be 2 or 4 or more.

In the present invention, the staggered arrangement of the movable tables 83 is not limited to arrangement in which the three movable tables 83 are arranged on the left side and the right side of the X-axis moving table 61 one by one alternately. For example, an arrangement may be adopted in which two of plural movable tables 83 are successively arranged to project from one side of the X-axis moving table 61, and the third movable table 83 is arranged to project from the other side of the table. Specifically, the movable tables 83 are preferably provided such that at least one of the tables 83 is projected from each end of one X-axis moving table 61, and movable tables 83 of adjacent applying heads 6, which are provided on the same guide rail 82, do not project in the opposite directions.

Further, in the above embodiment, the suction holes 10 serving as suction portions are provided under each of the guide rails 82 on the front surface of the beam member 5a. However, the suction holes may be provided above the guide rails 82, or above and under the guide rails. Furthermore, the suction portions are not limited to suction holes, but may be nozzles.

Although the device for moving the applying heads 6 in the above embodiment is a linear motor, the present invention is not limited to it. Another moving device, such as a moving device using a feed screw mechanism driven by motor, can be adopted.

In the above embodiment, the relative distance between the applying heads 6 is computed for each side of the rectangular application patterns P1 and P2 as shown in FIG. 5. However, the applying heads 6 are likely to interfere with each other when at least one of the applying heads 6 moves on facing sides of the application patterns P1 and P2.

Therefore, for example, the relative distance between the applying heads when one of the applying heads moves on a side facing the adjacent application pattern may be computed for each elapsed time during movement of the applying head on the side, and it may be judged whether the applying heads interfere with each other or not, based on determination as to whether the obtained relative distance is equal to or smaller than the set close distance or not.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An applying apparatus which applies paste in a preset pattern to a substrate, comprising:
a stage having a holding surface on which the substrate is placed;
a beam member extending above the stage in a direction along the holding surface;
a moving device which relatively moves the beam member and the stage, in a direction along the holding surface and perpendicular to the extending direction of the beam member;
a guide member provided on the beam member and along the extending direction of the beam member;
an applying head which is supported by the guide member and movable along the guide member; and
a plurality of suction portions which are provided along the guide member and suck air in the vicinity of the guide member.

2. A paste applying apparatus according to claim 1, wherein the suction portions are provided under the guide member on a front surface of the beam member.

3. An applying apparatus which applies paste in a preset pattern to a substrate, comprising:
a stage having a holding surface on which the substrate is placed;
a beam member extending above the stage in a direction along the holding surface;
a first moving device which relatively moves the beam member and the stage, in a direction along the holding surface and perpendicular to the extending direction of the beam member;
a guide member provided on the beam member and along the extending direction of the beam member;
a plurality of applying heads which are supported by the guide member and movable along the guide member;
a second moving device which individually moves the plurality of applying heads along the guide member;
a storing section which stores application pattern data of the paste to be applied onto the substrate by the plurality of applying heads;
a setting section which sets an allowable close distance between the plurality of applying heads; and
a computing section which computes a relative distance between the applying heads in movement of the applying heads for each elapsed time during movement of the applying heads, on the basis of the application pattern data stored in the storing section, and judges whether the computed relative distance is equal to or smaller than the close distance set in the setting section or not.

4. An applying apparatus which applies paste in a preset pattern to a substrate, comprising:
a stage having a holding surface on which the substrate is placed;
a beam member extending above the stage in a direction along the holding surface;
a moving device which relatively moves the beam member and the stage, in a direction along the holding surface and perpendicular to the extending direction of the beam member;
a guide member provided on the beam member and along the extending direction of the beam member; and
a plurality of applying heads which are supported by the guide member and movable along the guide member;
wherein the guide member comprises: a plurality of guide rails arranged in parallel on the beam member;
and a plurality of movable tables movably attached to the respective guide rails,
the movable tables of each applying head are arranged in a staggered format with respect to the applying head in a moving direction of the applying head, and projecting directions of the movable tables are set to be the same between the applying heads.

5. An applying apparatus which applies paste in a preset pattern to a substrate, comprising:
a stage having a holding surface on which the substrate is placed;
a beam member extending above the stage in a direction along the holding surface;
a first moving device which relatively moves the beam member and the stage, in a direction along the holding surface and perpendicular to the extending direction of the beam member;
a plurality of guide members provided on the beam member and along the extending direction of the beam member, the guide members being provided in parallel and apart from each other in a direction crossing the extending direction of the beam member;
a plurality of applying heads which are movably supported by the respective guide members; and
a second moving device which individually moves the plurality of applying heads along the respective guide members;
wherein the second moving device is a linear motor comprising a plurality of stators and a plurality of moving elements, the stators are provided to the beam member and arranged on the beam member in parallel and along the respective guide members, and the moving elements are provided to the respective applying heads to be longer than the applying heads in a moving direction of the applying heads and opposed to the respective stators in different positions in the adjacent applying heads.

6. An applying method of applying paste in a preset pattern to a substrate by a plurality of applying heads, comprising:
placing the substrate on a holding surface of a stage;
moving relatively the substrate in a predetermined direction with respect to the applying heads;
moving the plurality of applying heads individually;
storing application pattern data of the paste to be applied onto the substrate by the plurality of applying heads;
setting an allowable close distance between the plurality of applying heads; and
computing a relative distance between the applying heads when the applying heads move for each elapsed time during movement of the applying heads, on the basis of the application pattern data, and judging whether the computed relative distance is equal to or smaller than the close distance or not.
